(19) United States
(12) Patent Application Publication
(10) Pub. No.: US 2014/0240132 A1
(43) Pub. Date: Aug. 28, 2014

(54) METHOD AND APPARATUS FOR DETERMINING VEHICLE OPERATOR PERFORMANCE

(71) Applicant: Exmovere Wireless LLC, Alexandria, VA (US)

(72) Inventor: David Bychkov, Alexandria, VA (US)

(73) Assignee: Exmovere Wireless LLC, Alexandria, VA (US)

(21) Appl. No.: 14/187,288

(22) Filed: Feb. 23, 2014

Related U.S. Application Data
(60) Provisional application No. 61/770,368, filed on Feb. 28, 2013.

(51) Int. Cl. G08B 21/02

(52) U.S. Cl. CPC G08B 21/02
USPC 340/576

(57) ABSTRACT

An approach is provided for determining one or more behavioral states of a vehicle operator and causing one or more alerts and/or one or more management options based on the determined one or more behavioral states. The approach involves causing physiological information associated with a vehicle operator to be collected by one or more sensors. The approach also involves causing, at least in part, the physiological information to be communicated to a device that comprises at least one of the one or more sensors or is remote from at least one of the one or more sensors. The approach further involves processing the physiological information to determine a behavioral state associated with the vehicle operator. The approach additionally involves causing, at least in part, one or more alerts to be communicated to a device associated with the vehicle operator based, at least in part, on the determined behavioral state.

### RELATED APPLICATIONS

This application claims the benefit of the earlier filing date of U.S. Provisional Application No. 61/770,368, filed Feb. 28, 2013, entitled “METHOD AND APPARATUS FOR DETERMINING VEHICLE OPERATOR PERFORMANCE,” by David Bychkov, the entirety of which is incorporated herein by reference, under 35 U.S.C. §119(e).

### BACKGROUND

Service providers and device manufacturers (e.g., wireless, cellular, those involved in the automotive industry, the airline industry, the public transportation industry, etc.) are challenged to deliver value and convenience to consumers by, for example, providing compelling network services. Such network services may include, for example, the ability to monitor the performance of a vehicle operator.

### Some Example Embodiments

Therefore, there is a need for an approach to determine one or more behavioral states of a vehicle operator and cause one or more alerts and/or one or more management options based on the determined one or more behavioral states.

According to one embodiment, a method comprises causing, at least in part, physiological information associated with a vehicle operator to be collected by one or more sensors. The method also comprises causing, at least in part, the physiological information to be communicated to a device that comprises at least one of the one or more sensors or is remote from at least one of the one or more sensors. The method further comprises processing the physiological information to determine a behavioral state associated with the vehicle operator. The method additionally comprises causing, at least in part, one or more alerts to be communicated to a device associated with the vehicle operator based, at least in part, on the determined behavioral state.

According to another embodiment, an apparatus comprises at least one processor, and at least one memory including computer program code for one or more computer programs, the at least one memory and the computer program code configured to, with the at least one processor, cause, at least in part, the apparatus to cause, at least in part, physiological information associated with a vehicle operator to be collected by one or more sensors. The apparatus is also caused to cause, at least in part, the physiological information to be communicated to a device that comprises at least one of the one or more sensors or is remote from at least one of the one or more sensors. The apparatus is further caused to process the physiological information to determine a behavioral state associated with the vehicle operator. The apparatus is additionally caused to cause, at least in part, one or more alerts to be communicated to a device associated with the vehicle operator based, at least in part, on the determined behavioral state.

According to another embodiment, a method comprises causing, at least in part, physiological information associated with a vehicle operator to be collected by one or more sensors. The method also comprises causing, at least in part, the physiological information to be communicated to a device that comprises at least one of the one or more sensors or is remote from at least one of the one or more sensors. The method further comprises processing the physiological information to determine a behavioral state associated with the vehicle operator. The method additionally comprises determining one or more trends associated with the stored physiological information and the behavioral state. The method also comprises causing, at least in part, a user profile to be generated based, at least in part, on the determined one or more trends, the behavioral state being determined based, at least in part, on a comparison of the physiological information and the user profile. The method further comprises facilitating access to the user profile by a management system associated with a vehicle occupied by the vehicle operator, the management system being capable of monitoring the vehicle operator based, at least in part, on accessing the user profile.

Exemplary embodiments are described herein. It is envisioned, however, that any system that incorporates features of any apparatus, method and/or system described herein are encompassed by the scope and spirit of the exemplary embodiments.

### BRIEF DESCRIPTION OF THE DRAWINGS

The embodiments are illustrated by way of example, and not by way of limitation, in the figures of the accompanying drawings:

FIG. 1 is a diagram of a system capable of determining one or more behavioral states of a vehicle operator and causing one or more alerts and/or one or more management options based on the determined one or more behavioral states, according to one or more embodiments.

FIG. 2 is a diagram of the components of a vehicle operator performance management platform, according to one or more embodiments.

FIG. 3 is a flowchart of a process of determining one or more behavioral states of a vehicle operator and causing one or more alerts and/or one or more management options based on the determined one or more behavioral states, according to one or more embodiments.

FIG. 4 is a diagram of a wearable UE 101, according to one or more embodiments.

FIG. 5 is a diagram of a hand-operated control apparatus configured to collect physiological information associated with a vehicle operator, according to one or more embodiments.

FIG. 6 is a diagram of a seat portion of a vehicle operated by a vehicle operator configured to collect physiological information associated with the vehicle operator, according to one or more embodiments.

FIG. 7a is a chart illustrating factors that contribute to a particular behavioral state, according to one or more embodiments.

FIG. 7b is a chart illustrating behavioral state and vehicle operator performance based on determined deviations from an ideal state, according to one or more embodiments.

FIG. 8b illustrates user interfaces utilized in the processes of FIG. 3, according to one or more embodiments.

FIG. 8a illustrates user interfaces utilized in the processes of FIG. 3, according to one or more embodiments.

FIG. 9 is a diagram of a chip set that can be used to implement an embodiment.

### DESCRIPTION OF SOME EMBODIMENTS

Examples of a method, apparatus, and system for determining one or more behavioral states of a vehicle operator and causing one or more alerts and/or one or more management options based on the determined one or more behavioral states are disclosed. In the following description, for the purposes of explanation, numerous specific details are set forth in order to provide a thorough understanding of the embodiments. It is apparent, however, to one skilled in the art that the embodiments may be practiced without these specific details or with an equivalent arrangement. In other instances, well-known structures and devices are shown in block diagram form in order to avoid unnecessarily obscuring the embodiments.

As used herein, the term “vehicle,” or any derivation thereof, refers to any of a car, a boat, a truck, a van, an airplane, a train, a helicopter, a hovercraft, a motorcycle, an all terrain vehicle, a bicycle, a lawn mower, a golf cart, or other suitable machine usable for transportation.

As used herein, the term “vehicle operator,” or any derivation thereof, refers to a person or user of a vehicle that is a driver, pilot, or any person that controls a vehicle's direction and/or motion.

As used herein, the term “behavioral state,” or any derivation thereof, refers to one or more of alert, excited, depressed, involved, uninvolved, energetic, sleepy, fatigued, bored, engaged, disengaged, calm, complacent, distracted, frustrated, stressed, relaxed, peaceful, busy, ready, ideal, confident, happy, joyful, sad, downbeat, impaired, assessed vehicle operator performance, or other determinable behavioral state.

As used here, the term “physiological information,” or any derivation thereof, refers to any combination of a physical position of a vehicle operator, a body temperature of the vehicle operator, a skin temperature of the vehicle operator, a heart rate of the vehicle operator, a movement of the vehicle operator, a sight line of the vehicle operator, a g-force experienced by the vehicle operator, a sweat level of the vehicle operator, a blood oxygen level of the vehicle operator, blood a glucose level of the vehicle operator, a blood alcohol content level of the vehicle operator, or other suitable determinable physiological information usable to determine a behavioral state of a physiological condition of the vehicle operator.

As used herein, the term “sensor,” or any derivation thereof, refers to a device capable of collecting data associated with or determining physiological information such as an infrared (IR) sensor, a global positioning system (GPS) unit, an accelerometer, a three-axis accelerometer, a gyroscope, a thermistor sensor, an optical sensor, a pressure sensor, an audio sensor or other suitable sensor capable of collecting data associated with or determining physiological information of a vehicle operator.

As used herein, the term “biosensor populated fabric” refers to any combination of a fabric configured to accommodate one or more sensors and a fabric having integrated sensory capabilities such as, but not limited to, sensors associated with any fibers of the fabric itself.

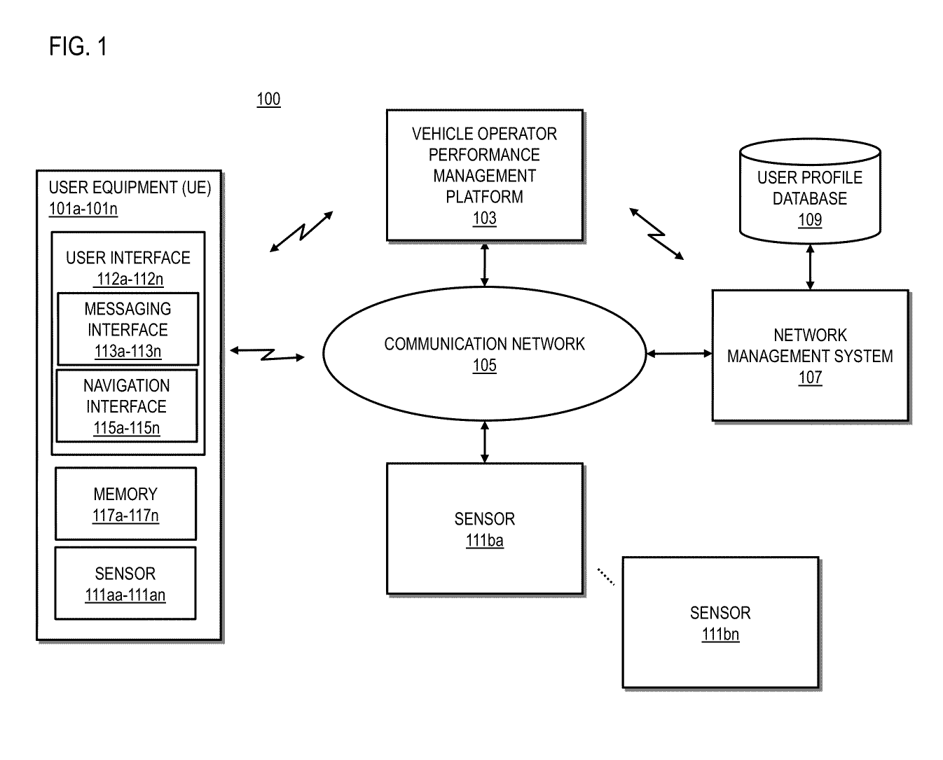

FIG. 1 is a diagram of a system capable of determining one or more behavioral states of a vehicle operator and causing one or more alerts and/or one or more management options based on the determined one or more behavioral states, according to one or more embodiments.

Service providers, fleet managers, healthcare providers, vehicle operators, and insurance carriers, for example, are often interested in monitoring a vehicle operator's performance. For example, the vehicle operator's performance could be tied to vehicle operator efficiency, vehicle operator productivity, and/or accidents. Accidents may be avoided if, for example, the vehicle operator is warned that their performance is less than optimal, a vehicle operator is not be allowed to operate a vehicle if their performance is less than optimal, or if it is anticipated that their performance may be less than optimal in the future.

To address this problem, a system 100 of FIG. 1 introduces the capability to determine one or more behavioral states of a vehicle operator and cause one or more alerts and/or one or more management options based on the determined one or more behavioral states. The system 100 is configured to monitor a vehicle operator's physiological information, operating habits, current vehicle operating performance, any potential distractions, and potential external vehicular obstructions, for example, to determine one or more of a behavioral state of the vehicle operator, vehicle operator performance, and to determine if any potential hazards exist. The system 100, then based on any behavioral state concerns, vehicle operator performance concerns, or potential hazard concerns, alerts a vehicle operator, system administrator, or service provider, for example, about such a concern to avoid a potential accident, or to disable the vehicle operator's ability to pilot the vehicle.

For example, the system 100 ensures that the vehicle operator is fully energized and alert when operating the vehicle to avoid falling asleep while controlling the vehicle and to avoid excessive fatigue. The system 100 also ensures that the vehicle operator is not distracted by emotions, health hazards, food, music, phone use, other entertainment devices such as visual displays, alcohol use, or drug use, or other type of distraction, impairment, or combination thereof.

To achieve these assurances, the system 100 is configured to send alerts, or messages, that are any combination of visual, textual, audio or haptic, to one or more of the vehicle operator and a remote monitoring system if the vehicle operator falls outside of particular threshold parameters associated with ideal operation of the vehicle for a certain period of time, with a particular frequency during operation, or within a particular period of time.

The system 100 enables remote health diagnostics by way of a remote health service provider or default system care application and facilitate counseling, treatment, or care in case of an accident or emergency.

Additionally, the system 100 collects and provides one or more of raw and processed data to fleet managers, health care providers, insurance carriers, other service providers, and authorities such as police, fire, etc. The raw or processed data enables a higher level of restriction of vehicle operation should the vehicle operator be out of the above-mentioned ideal range of operation by a predetermined amount.

As shown in FIG. 1, the system 100 comprises one or more user equipment (UE) devices 101a-101n (collectively referred to herein as “UE 101”) having connectivity to a vehicle operator performance management platform 103, a network management system 107, a user profile database 109, and one or more sensors 111aa-111bn (collectively referred to herein as “sensor 111”) either directly, or via a communication network 105. The vehicle operator performance management platform 103 is one or more of a standalone feature, or is unitary with, or associated with the UE 101 and/or the network management system 107.

The UE 101 is a body-mounted device, or can support any type of interface to the user (such as “wearable” circuitry, etc.), that is mounted, worn, or implanted, on or in one or more of a vehicle operator's wrist, arm, hand, torso, neck, head, abdomen, leg, ankle, foot, or other suitable bodily position from which biometric information is capable of being collected or sensed. Though discussed primarily as a body-mounted device, it should be noted that the UE 101 may be any type of mobile terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof.

In some embodiments, if the UE 101 is wearable, the UE 101 is a body-mounted device configured to be wearable by a vehicle operator of any age or gender. In embodiments, the UE 101 is configured to be a bracelet, a watch, an anklet, or other suitable bodily worn device or combination thereof. In some embodiments, the UE 101 is configured to be a biosensor populated fabric in the form of a shirt, a pair of pants, a pair of shorts, a one-piece body suit, a hat, a glove, a sock, a belt, eyewear, a necklace, a strap, or other suitable bodily worn device, or combination thereof. In some embodiments, the UE 101 comprises a tightening portion configured to facilitate consistent contact with a skin surface. The tightening portion includes, for example, an elastic material, zipper, tie, or other suitable fastener that facilitates conforming one or more portions of the UE 101 to a user's body. The tightening portion is positioned on the UE 101 in a location that corresponds to a desired data reception area such as, but not limited to, a waist line, stomach, chest, back, temple, wrist, finger tip, palm, ankle, neck, thigh, calf, arm, forehead, etc. In some embodiments, if the UE 101 comprises a biosensor populated fabric, the biosensor populated fabric includes a communication port configured to facilitate external connectivity to the at least one sensor 111, the external connectivity being one or more of physical connectivity or wireless connectivity.

In some embodiments, the UE 101 includes one or more sensors 111aa-111an. In other embodiments, the UE 101 is free from having sensors 111, and is instead in communication with one or more sensors 111ba-111bn either directly or indirectly. In some embodiments, the system 100 includes one or more sensors 111 within only UE 101. In other embodiments, the system 100 includes two or more sensors 111, at least one sensor 111 being within the UE 101 and at least one sensor 111 being external to the UE 101. In some embodiments, the UE 101 includes a corresponding user interface 112-112n (collectively referred to herein as user interface 112), a corresponding messaging interface 113a-113n (collectively referred to herein as messaging interface 113), a corresponding navigation interface 115a-115n (collectively referred to herein as navigation interface 115), and a corresponding memory 117a-117n (collectively referred to herein as memory 117).

In some embodiments, a vehicle operator controls a vehicle using his hands, for example, and operates a vehicle while sitting or standing. The sensors 111 are configured to collect physiological information associated with the vehicle operator such as, but not limited to, a physical position of the vehicle operator, a sight line of the vehicle operator, a body temperature of the vehicle operator, a skin temperature of the vehicle operator, a heart rate of the vehicle operator, a movement of the vehicle operator, a sweat level of the vehicle operator, a g-force experienced by the vehicle operator, a blood glucose level of the vehicle operator, a blood oxygen level of the vehicle operator and/or a blood alcohol content level of the vehicle operator.

The sensors 111 comprise, for example, one or more devices capable of collecting data associated with or determining physiological information such as an infrared (IR) sensor, a global positioning system (GPS) unit, an accelerometer, a three-axis accelerometer, a gyroscope, a thermistor sensor, an optical sensor, a pressure sensor, an audio sensor or other suitable sensor capable of collecting data associated with or determining physiological information of a vehicle operator.

The sensors 111 are in communication with, for example, the vehicle operator performance management platform 103 by way of a communication unit associated with any of the sensors 111, for example, a communication unit on board the UE 101 because the UE 101 is a mobile communication device, and/or a communication unit coupled to the sensors 111. The vehicle operator performance management platform 103, accordingly either processes the physiological information or causes the physiological information to be processed by the UE 101 and/or the network management system 107. The processing of the physiological information is used to determine a behavioral state associated with the vehicle operator.

In some embodiments, the behavioral state of the vehicle operator is determined to be one or more of alert, excited, depressed, involved, uninvolved, energetic, sleepy, fatigued, bored, engaged, disengaged, calm, complacent, distracted, frustrated, stressed, relaxed, peaceful, busy, ready, ideal, confident, happy, joyful, sad, downbeat, impaired, assessed vehicle operator performance, or other determinable behavioral state. The behavioral state is based on instantaneous physiological information or a determined change in physiological information compared to a normal status of physiological information as indicated in a user profile stored in user profile database 109, for example, or based on a determined change in behavioral state from a previously known or user profile defined normal behavioral state.

Depending on one or more system settings, the vehicle operator performance management platform 103 causes one or more alerts to be communicated to the UE 101 associated with the vehicle operator based, at least in part, on the determined behavioral state.

In some embodiments, the vehicle operator performance management platform 103 and/or the network management system 107 causes one or more of the physiological information and the behavioral state to be stored in a memory such as, for example, the user profile database 109 or the memory 117. The storage is caused to occur at one or more of at the time of collection, at the time of processing, at the time a determined change in physiological information occurs that meets a predefined threshold, at the time a change in behavioral state occurs that meets a predefined threshold, at a predetermined time, and at a predefined interval, or at another suitable time.

The vehicle operator performance management platform 103 and/or the network management system 107 use any stored information such as the physiological information and/or determined behavioral state to determine one or more trends associated with the stored physiological information and the behavioral state such as normal behavior, baseline physiological information, or trends in changes of behavior and/or physiological information. The trends are used to generate a user profile for the vehicle operator. As discussed above, a determined behavioral state is optionally based not only on current physiological information but also based on trends stored in the user profile database 109, behavioral states stored in the user profile database 109, and/or physiological information stored in the user profile database 109. For example, a trend may indicate that a vehicle operator tends to become fatigued after three hours of operating a vehicle. But, the present physiological information indicates that the vehicle operator is not fatigued. Such information, which is occurring outside the normal trend optionally triggers an alert to indicate that the vehicle operator should be cautious in the time to come.

In some embodiments, in addition to storing determined behavioral states, physiological information, developed a user profiles based on behavioral states and physiological information, and trends, the vehicle operator performance management platform 103 also causes continual or periodic storage of information in the user profile database 109 relating to how a vehicle operator controls the vehicle based on one or more vehicle performance factors or vehicle performance information such as how fast the vehicle operator drives, how fast the vehicle operator accelerates, how hard or often the vehicle operator brakes, how well the vehicle operator controls a vehicle transmission, how sharp the vehicle operator takes turn, whether the vehicle operator drives two-footed with a foot on the accelerator and the brake at the same time, the routes the vehicle operator takes to navigate certain places, the locations the vehicle operator spends time, how long the vehicle operator is behind the wheel, how much fuel the vehicle controlled by the vehicle operator consumes for various time periods, or any other suitable metric capable of being processed to evaluate the performance of a vehicle operator.

In some embodiments, the vehicle operator performance management platform 103 determines the behavioral state of a vehicle operator based, at least in part, on collected vehicle performance information. For example, if the vehicle operator performance management platform 103 identifies a trend that associates fast driving with stress as opposed to happiness, such information is stored in the user profile database 109 and weighted when vehicle operator later drives over the speed limit.

In some embodiments, the user profile generated by the vehicle operator performance management platform 103 and stored in the user profile database 109 establishes baseline settings that are associated with alert vehicle operation. Then, if the vehicle operator performance management platform 103 determines that the physiological information indicates a behavioral state that is outside of the alert vehicle operation norm by a predetermined setting, the vehicle operator performance management platform 103 causes an alert to be communicated to one or more of the UE 101, devices associated with the sensors 111, the network management system 107, an administrator of the network management system 107 by way of a device or interface associated with such an administrator, or an outside emergency service or authority, for example. In other words, some types of alerts, as well as a designated recipient of the alert, are optionally based, at least in part, on a comparison of the determined behavioral state and the user profile.

In some embodiments, the vehicle operator performance management platform 103 is configured to determine that one or more entertainment or communication capable devices are operating, and the behavioral state is further based, at least in part, on a determined operation status of the one or more entertainment or communication capable devices. For example, in some embodiments, the vehicle operator performance management platform 103 is configured to determine if a vehicle operator is using a communication device to send messages while operating the vehicle, talking while operating the vehicle, watching a movie while operating the vehicle, listening to music while operating the vehicle, a level of volume of any media that might be distracting to the vehicle operator.

For example, in some embodiments, the vehicle operator performance management platform 103 determines if an entertainment or communication device is operating based on one or more of a communication with the operating communication or entertainment device, or information collected by the sensors 111 such as data collected by way of an audio sensor and/or an optical sensor. An optical sensor, for example, makes it possible for the vehicle operator performance management platform 103 to determine a line of sight of the vehicle operator to discern if the vehicle operator is watching the road or direction of movement of the vehicle, or is pre-occupied with something else, such as looking at the UE 101.

In some embodiments, together with facial recognition software instructions and at least one optical sensor, the vehicle operator performance management platform 103 determines if the vehicle operator is facing a particular direction while operating the vehicle. For example, a facial match indicates the vehicle operator is facing an intended direction if that is the direction the vehicle operator is supposed to be facing while operating the vehicle. In other embodiments, a facial match indicates the vehicle operator is facing in an improper direction while operating the vehicle because the sensor 111 that is the optical sensor, for example, is receptive from a direction away from the direction the vehicle operator should face when operating the vehicle.

Similarly, based on information collected by the sensors 111, the vehicle operator performance management platform 103 is configured to determine if a vehicle operator's hands or feet are pre-occupied with a function other than operating the vehicle such as shaving, putting on make-up, consuming food, hand outside the vehicle, hand elsewhere in the vehicle, hand on gear shifter or drive controller, etc. For example, if the UE 101 is worn by the vehicle operator on the vehicle operator's wrist, and at least one of the sensors 111 onboard the UE 101 is a location information providing sensor such as a GPS unit, an accelerometer, a three-axis accelerometer, or a gyroscope, the vehicle operator performance management platform 103 is configured to determine the user is, or at least the user's hand is, outside the vehicle, or away from a determined normal operating position (e.g., on the steering wheel).

In some embodiments, the UE 101 includes user interface 112 that comprises the messaging interface 113 and the navigation interface 115. The user interface 112 enables one or more of control of the one or more alerts such as by way of the messaging interface 113. The messaging interface 113 facilitates any combination of media messages such as, but not limited to, audio messages, two-way-voice communication, textual messages, multi-media messages, etc. In some embodiments, the messaging interface 113 facilitates a question and answer session of messaging to determine a vehicle operator's behavioral state.

In some embodiments, the user interface 112 is linked to a control management system of the vehicle itself and enables management of the vehicle operated by the vehicle operator such as, but not limited to, ignition, power consumption, audio controls, vehicle operating statistics, auto-pilot control, navigation, acceleration, deceleration, braking, direction of movement, gear selection, ride stiffness control, etc. In some embodiments, the user interface 112 enables management of a generated user profile stored in user profile database 109 associated with the vehicle operator.

Accordingly, by way of the user interface 112, the UE 101 is configured to present the one or more alerts, provide first aid guidance, provide navigation instructions based, at least in part, on the determined behavioral state, or provide other suitable messages or suggestions. For example, if the vehicle operator performance management platform 103 determines that a vehicle operator is stressed, the navigation interface 115 optionally proposes the vehicle operator follow an alternate route to the desired destination. Such alternate route may be, for example, a country road as opposed to a congested highway. Or, based on a determined behavioral state, determined physiological information, and/or determined vehicular performance information such as determined speeds, direction of movement, pace of changes between speeds and direction of movement, constant braking and/or accelerating, etc., based on data collected by the one or more sensors 111, the vehicle operator management platform 103 optionally causes the navigation interface 115 to suggest a route of travel that is better suited to the vehicle operator's capabilities.

If the vehicle operator is fatigued, the vehicle operator management platform 103 optionally causes the navigation interface 115 to indicate directions to the nearest hotel. The vehicle operator management platform 103 causes the messaging interface 113 to alert the vehicle operator that he is fatigued and suggests taking a break from operating the vehicle. Such a hotel selection is optionally based on user preferences determined based on tendencies or preset by the user to include a particular brand, location, or type of hotel, for example.

In some embodiments, if the operator is fatigued, and the vehicle operator performance management platform 103 is so configured, the vehicle operator performance management platform 103 causes the messaging interface 113 to alert the vehicle operator that the vehicle will cease operation in a predetermined period of time and remain disabled for a predefined period of time, thereby forcing the vehicle operator to rest for the predefined period of time. The predetermined period of time for disablement is based on a setting made by the network management system 107, or it is based on a determined distance to the nearest or preferred hotel or rest area, for example.

In some embodiments, the network management system 107 is configured to control operation of the vehicle, control the sending of alerts to a recipient, and monitor the vehicle operator's performance and changes in physiological information and behavioral state. For example, in some embodiments, the vehicle operator performance management platform 103 facilitates access to a user profile for a vehicle by the network management system 107 associated with a vehicle occupied by the vehicle operator. The network management system 107, for example, is capable of monitoring the vehicle operator based, at least in part, on accessing the user profile.

In some embodiments, a network management system 107 administrator, for example, has the ability to review vehicle operator performance using the information available in the user profile database 109 and/or based on the user profile itself. The network management system 107 administrator can also compare the vehicle operator against other vehicle operators to assess performance and/or vehicle operator health.

In some embodiments, the vehicle operator performance management platform 103 makes it possible for a network management system 107 administrator to take action regarding whether the vehicle should be allowed to operate or be rendered inoperable based on the user profile, determined behavioral state, current driver performance, and/or physiological information thereby taking control of the vehicle in an operability respect. Accordingly, the vehicle operator performance management platform 103 is configured to cause the vehicle to be rendered inoperable based on a received instruction from the network management system 107.

In some embodiments, the vehicle operator performance management platform 103 makes it possible for a network management system 107 administrator to take remote control of the vehicle based, for example, on an alert generated with respect to the vehicle operator's behavioral state and/or physiological information if the vehicle is so equipped, and the one or more sensors 111 make it possible to control the vehicle remotely. Accordingly, the vehicle operator performance management platform 103, based on an instruction received from the network management system 107, causes the controls of the vehicle to be rendered inoperable such that the vehicle can no longer be controlled by the vehicle operator, and relinquishing control to the network management system 107.

In some embodiments, the vehicle operator performance management platform 103 facilitates direct communication between a network management system 107 administrator and the vehicle operator by way of UE 101, for example, based on what the administrator sees in the user profile, or based on an alert that is generated and sent to the network management system 107, the alert being based, for example, on the behavioral state of the vehicle operator, the vehicle operator's performance, the vehicle operator's physiological information, and/or a determined condition of the vehicle.

In some embodiments, to collect physiological information, the sensors 111aa-111an are positioned on or in UE 101 and optionally in contact with a vehicle operator's skin. In some embodiments, the sensors 111 on or in the UE 101 collect physiological information such as location information associated with hand, arm, body, leg, and/or foot position or orientation. The vehicle operator performance management platform 103 determines, based on the collected location information, whether a vehicle operator's hands are at a control position such as on a steering wheel or control stick, or away from the control position. Similarly, vehicle operator performance management platform 103 determines, based on the collected location information, the vehicle operator's body orientation such as upright, slouching, moving, etc. The vehicle operator performance management platform 103 is also configured to determine how active or engaged the vehicle operator is based, at least in part, on determined movements that the vehicle operator makes such as steering, gear shifting, or movement determined to be unrelated to vehicle operation based, at least in part, on the collected location information.

In some embodiments, to collect physiological information, the sensors 111ba-111bn are positioned anywhere on, in, inside or outside a vehicle. For example, in some embodiments, the sensors 111ba-111bn include one or more sensors 111 associated with a hand-operated control apparatus such as, but not limited to, a steering wheel, a control stick, a gear shifter, a directional control, a control handle, etc. In some embodiments, the hand-operated control apparatus includes a cover portion. The cover portion is separately formed and later attached to a hand-operated control apparatus, or the cover portion is integrally formed or attached at a time of manufacture of the hand-operated control apparatus or vehicle. In some embodiments, at least one of the one or more sensors 111 is positioned on the cover portion, while in other embodiments, at least one of the one or more sensors 111 is integrally formed with the cover portion.

The cover portion comprises a material that either accommodates, integrates, or is a sensor 111. For example, in some embodiments, the cover portion comprises a conductive material configured to collect at least part of the physiological information such as, but not limited to, a conductive silicon.

In some embodiments, the hand-operated control apparatus comprises a circular portion and the one or more sensors 111 associated with the hand-operated control apparatus are positioned on the circular portion. It should be noted, however, that the hand-operated control apparatus comprises any shape such as a handle, rod, knob, button or series of buttons, etc.

According to various embodiments, the cover portion comprises at least two parts to determine whether the vehicle operator is contacting one or more of the at least two parts of the cover portion. For example, the two parts of the cover portion are used to determine if the vehicle operator is using one or two hands to operate the vehicle. In other embodiments, the cover portion comprises at least six parts, the at least six parts being used to determine the vehicle operator is contacting one or more of the at least six parts, and to determine more precisely which position on the hand-held control apparatus is vehicle operator is contacting to, for example, extrapolate vehicle operator hand position on the hand-operated control apparatus.

In some embodiments, the cover portion includes any number of parts to even more precisely determine vehicle operator hand position such as, for example, 12 parts positioned around a circular portion of the hand-held control apparatus, if it is so configured, equally spaced like 12 hours on a clock. Accordingly, the vehicle operator performance management platform 103 is configured to determine whether the vehicle operator's hands are at 10 and 2 on the circular portion of the cover portion, 9 and 3, or if the vehicle operator takes on hand off the hand-held control apparatus during a turn, what type of turn, for how long, at what position is the hand removed from the hand-held control apparatus while the vehicle is turning, and at what point does the vehicle operator return a hand to the hand-held control apparatus during or after a turn, and at what position that hand does return to the hand-held control apparatus, for example.

Determinations such as vehicle operator hand position, regardless of whether such a determination is made based on information collected by sensors 111aa-111an or sensors 111ba-111bn, are considered to be included in the above-discussed physiological information and used to assess the vehicle operator's behavioral state.

In some embodiments, the UE 101 and/or the cover portion further comprise one or more sensors 111 configured to determine a vehicle operator's body temperature. Such body and/or skin temperature determination is accomplished by one or more of a thermistor sensor 111 and/or an infrared temperature sensor 111 configured to determine a temperature of the vehicle operator, the temperature being measured from a vehicle operator's wrist, face, palm, or other body part. In some embodiments, the sensor 111 is configured to collect temperature data from the vehicle operator is a temperature sensor 111 is integrated into a UE 101 worn on the vehicle operator's wrist, for example. In other embodiments, the sensor 111 configured to collect temperature data from the vehicle operator is a temperature sensor 111 configured to collect temperature data as the vehicle operator touches or grasps a portion of the hand-held control apparatus.

In one or more embodiments, the one or more sensors 111 associated with the UE 101 and/or the hand-held control apparatus are configured to collect physiological information such as, but not limited to heart rate, humidity, skin moisture, amount of sweat produced by a vehicle operator, or other suitable physiological information. In some embodiments, skin moisture is converted or measured based on a relativity scale such as 1-100, for example. Heart rate is measured with respect to any time such as, but not limited to, beats per minute, beats per second, beats per hour, etc.

In some embodiments, the one or more sensors 111 associated with the UE 101 and/or the hand-held control apparatus include one or more sensors 111 configured to determine one or more of a speed and a direction of movement of the UE 101 and/or the hand-operated control apparatus. For example, a sensor 111 in this case could be an accelerometer, GPS, gyroscope, or other suitable motion-detection sensor. The behavioral state of the vehicle operator and/or the vehicle operator performance is further based, for example, on the speed and direction of movement of the UE 101 and/or the hand-operated control apparatus.

For example, if the vehicle operator quickly jerks to the left and/or quickly jerks the hand-held control apparatus to the left, while having an elevated heart rate, and producing an increased amount of sweat, the vehicle operator performance management platform 103 may determine that the vehicle operator is stressed. In some embodiments, the speed of movement of the UE 101 and/or the hand-held control apparatus is established to fall into a low, medium, or high threshold categorization, for example, or it is used for behavioral state determination by considering the exact value of determined speed.

In one or more embodiments, the UE 101 and/or the hand-operated control apparatus and/or the cover portion, comprises a communication unit configured to transmit data collected by the one or more sensors 111 to the vehicle operator performance management platform 103. The vehicle operator performance management platform 103, accordingly causes the data collected to be processed for determining a behavioral state, and/or stored by the network management system 107 and/or the UE 101 in the memory 117.

In other embodiments, the UE 101 and/or communication unit associated with the hand-operated control apparatus and/or the cover portion, is further configured to receive an instruction from the vehicle operation performance management platform 103. The UE 101 and/or the hand-operated control apparatus further comprises a haptic alert unit. In this example embodiment, the vehicle operator performance management platform 103, the UE 101 and/or the network management system 107 cause the haptic alert unit to notify the vehicle operator by a sensory indication that an alert has been received by the communication unit based, at least in part, on the instruction. For example, if the vehicle operator performance management platform 103 determines that the vehicle operator is fatigued, the haptic alert unit alerts the vehicle operator by way of a sensory indication such as a vibration of the UE 101, and/or a movement, a change in pressure or shape of the hand-held control apparatus, or a vibration of the hand-held control apparatus, for example. The sensory indication is one that is intended to wake up the vehicle operator, or one that indicates that a message or alert is available on the messaging interface 113.

In some embodiments, the one or more sensors 111 include sensors 111 that are configured to collect information associated with one or more obstructions surrounding the vehicle, and at least one of the one or more alerts corresponds to a determined obstruction. For example, the vehicle operator performance management platform 103 is configured to cause, at least in part, the sensory indication to occur via the UE 101 and/or on a portion of the hand-operated control apparatus that corresponds to a direction of the determined obstruction from the hand-operated control apparatus. Similarly, such directional determination of an obstruction is optionally based on a predicted direction of movement of the vehicle based on a drive direction, a UE 101 movement direction, a hand-held control apparatus movement direction, or an input such as, but not limited to, a UE 101 determined turn signal operation. For example, either based on a determined movement of the UE 101, or based on a communication with the vehicle control system, the vehicle operator performance management system 103 is configured to determine if a turn signal has been actuated by the user.

According to various embodiments, the one or more sensors 111 additionally or alternatively include one or more sensors 111 associated with a seat portion of a vehicle operated by the vehicle operator. The seat portion, for example, optionally comprises one or more sensors associated with determining a posture of the vehicle operator. In some embodiments, hand position discussed above with respect to the UE 101 and/or the hand-held control apparatus is additionally or alternatively used to determine the posture of a vehicle operator either along, or in conjunction, with a determined posture based, at least in part, on data collected from one or more sensors 111 associated with the seat portion.

In one or more embodiments, the seat portion comprises a cover portion. The cover portion of the seat portion, like the cover portion discussed above with respect to the hand-held control apparatus, has one or more sensors 111 positioned on or in the cover portion. The cover portion of the seat portion is separately formed and later attached to the seat portion, or the cover portion of the seat portion is integrally formed or attached at a time of manufacture of the seat portion or the vehicle. In some embodiments, at least one of the one or more sensors 111 is positioned on the cover portion of the seat portion, while in other embodiments, at least one of the one or more sensors 111 is integrally formed with the cover portion of the seat portion.

In some embodiments, the seat portion comprises a material such as, but not limited to, leather, vinyl, cloth, plastic, foam, carbon fibre, metal of any kind, or other suitable material. The cover portion of the seat portion comprises at least two sensors 111 configured to determine pressure associated with one or more legs, or buttocks positions of the vehicle operator. In some embodiments, the vehicle operator performance management platform 103 determines the vehicle operator is using one or more of a left leg and a right leg to operate the vehicle based, at least in part, on the determined pressure associated with the one or more legs of the vehicle operator. Additionally, the vehicle operator performance management platform 103 is configured to, based on a determined left leg and/or right leg operation, indicate the vehicle operator is using or more of a left foot and a right foot to operate the vehicle. The vehicle operator performance management platform 103 optionally uses this information as physiological information and determine a behavioral state of the user, determine how the user normally operates the vehicle.

In some embodiments, the cover portion of the seat portion additionally comprises a back portion and one or more sensors 111 in the back portion. Accordingly, the vehicle operator performance management platform 103 optionally determines the posture of the vehicle operator based, at least in part, on data collected from the one or more sensors 111 in the back portion. In some embodiments, the vehicle operator performance management platform 103 is configured to determine that a vehicle operator is lying back or sitting upright in the seat portion. In other embodiments, the cover portion further comprises one or more sensors 111 configured to facilitate a determination of a side of the cover portion of the seat portion toward which the vehicle operator is leaning, and the posture of the vehicle operator is further based a determined side to which the vehicle operator is leaning. For example, the vehicle operator performance management platform 103 is configured to determine that a vehicle operator is slouching in a particular direction while operating the vehicle. As discussed above, a determined behavioral state is optionally based, at least in part, on physiological information that includes the determined posture of the vehicle operator.

In view of the above-discussed examples of sensors 111 included in the seat portion, the seat portion comprises any number of sensors 111 positioned in any location among the seat portion, including the back portion. In some embodiments, the seat portion includes eight pressure sensors with two under the vehicle operator's buttocks, two under the vehicle operator's thighs, and four in the back portion.

Similar to the UE 101 and/or the hand-held control apparatus, the seat portion and/or cover portion of the seat portion includes a communication unit configured to transmit data collected by the one or more sensors 111 of the seat portion to the UE 101 and/or the vehicle operation performance management platform 103. The vehicle operator performance management platform 103, accordingly causes the data collected to be processed for determining a behavioral state, and/or stored by the network management system 107 and/or the UE 101 in memory 117.

In other embodiments, the communication unit of the seat portion is further configured to receive an instruction from the UE 101 and/or the vehicle operator performance management platform 103, for example, and the seat portion further comprises a haptic alert unit. In this example embodiment, the vehicle operator performance management platform 103, the UE 101 and/or the network management system 107 optionally cause the haptic alert unit to notify the vehicle operator by a sensory indication that an alert has been received by the communication unit based, at least in part, on the instruction. For example, if the vehicle operator performance management platform 103 determines that the vehicle operator is fatigued, the haptic alert unit optionally alerts the vehicle operator by way of a sensory indication that is a movement, change in pressure or shape of the seat portion, or a vibration, for example. The sensory indication is one that is intended to wake up the vehicle operator, or is one that merely indicates that a message or alert is available on the messaging interface 113.

In some embodiments, the one or more sensors 111 include sensors 111 that are configured to collect information associated with one or more obstructions surrounding the vehicle, and at least one of the one or more alerts corresponds to a determined obstruction. For example, the vehicle operator performance management platform 103 causes, at least in part, the sensory indication to occur on a portion of the seat portion that corresponds to a direction of the determined obstruction from seat portion. Similarly, such directional determination of an obstruction is optionally based on a predicted direction of movement of the vehicle based on a drive direction, hand-held control apparatus movement direction, or input such as, but not limited to, a UE 101 determined turn signal operation.

The seat portion includes any number of haptic alert units positioned in any location of the seat portion including the back portion. In some embodiments, the seat portion includes one haptic alert unit, while in other embodiments, the seat portion includes two haptic alert units individually positioned beneath the vehicle operator's thighs. In other embodiments, one or more haptic alert units are positioned in the back portion.

As discussed above, the vehicle operator performance management platform 103 causes the collection of various physiological information that includes vehicle operator posture and various forms of biometric data. From this information, and potentially based on previously stored physiological information, vehicle operator performance, and/or determined behavioral states, the vehicle operator performance management platform 103 is configured to determine that a vehicle operator is any of reclined, upright, leaning, has foot fatigue, has a risk of foot fatigue that is any of low, medium or high, and causes one or more alerts that either appear on the UE 101 via the user interface 112, or are indicated by haptic sensory indication.

In some embodiments, based on a determined behavioral state or vehicle operator selection made via user interface 112, the vehicle operator performance management platform 103 is configured to generate messages for display via user interface 112 that include, for example, suggestions to stretch, perform leg or foot exercises, a reminder to stop driving an eat, a reminder to drink water, messages that make a vehicle operator perform a driver impairment or intoxication test, messages that include first aid advice, CPR instructions, messages associated with a sleepy or fatigued driver test, or other suitable communications. In some embodiments, the vehicle operator performance management platform 103 is configured to halt operation of the vehicle if, for example, the vehicle operator fails a driver impairment, driver intoxication, or driver sleepiness/fatigue test.

By way of example, the communication network 105 of system 100 includes one or more of a direct wired or wireless communication channel, and/or one or more networks such as a wired data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), WiGig, wireless LAN (WLAN), Bluetooth®, Internet Protocol (IP) data casting, satellite, mobile ad-hoc network (MANET), and the like, or any combination thereof.

By way of example, the UE 101, vehicle operator performance management platform 103 (if not solely integrated into the UE 101), the network management system 107 and sensors 111 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

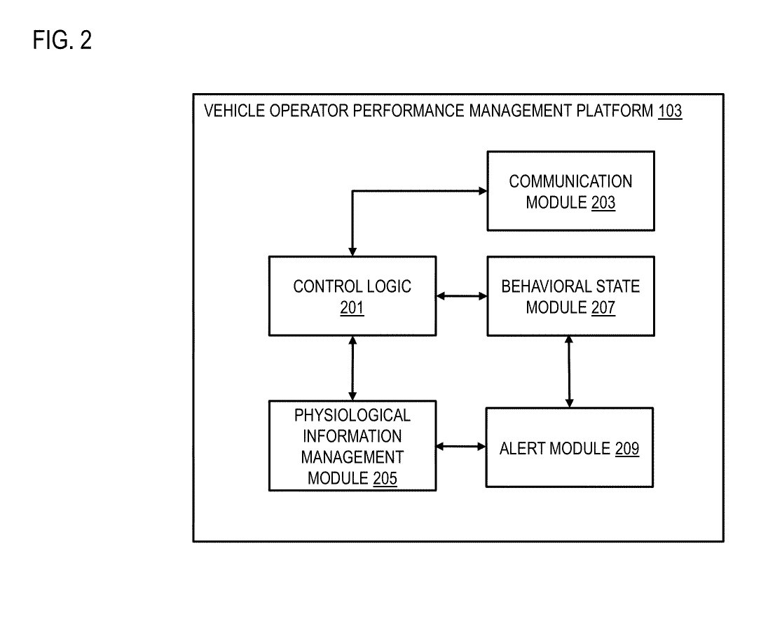

FIG. 2 is a diagram of the components of vehicle operator performance management platform 103, according to one embodiment. By way of example, the vehicle operator performance management platform 103 includes one or more components for determining one or more behavioral states of a vehicle operator and causing one or more alerts and/or one or more management options based on the determined one or more behavioral states. It is contemplated that the functions of these components may be combined in one or more components or performed by other components of equivalent functionality. In this embodiment, the vehicle operator performance management platform 103 includes a control logic 201, a communication module 203, a physiological information management module 205, a behavioral state module 207, and an alert module 209.

According to various embodiments, the vehicle operator performance management platform causes, facilitates, and/or determines any of the collection of physiological information, behavioral states, sending of alerts, etc.

For example, the control logic 201 causes the one or more sensors 111 (FIG. 1) discussed above to collect physiological information, and/or to provide vehicle performance data to the vehicle operator performance management platform 103, the UE 101 (FIG. 1), and/or the network management system 107 (FIG. 1) by way of the communication module 203. The vehicle operator performance management platform 103 then processes the received physiological information and/or vehicle performance data to determine a behavioral state. The behavioral state is based, as discussed above, on current data, or on a comparison to data stored in a user profile. The behavioral state module 207 determines the behavioral state based on one or more of current physiological information, most recent determined behavioral states, trends in behavioral state and physiological information, and/or vehicle performance data.

The physiological information management module 205 determines if any changes in physiological information are worth reporting to the behavioral state module 207 and also controls the timing at which physiological information is collected. The alert module 209 determines if and when an alert should be sent by the vehicle operator performance management platform 103 to the UE 101, the network management system 107, and/or any administrators, healthcare providers, etc. based, at least in part, on predetermined criteria that could trigger the need to send an alert. If the alert module 209 determines an alert should be sent, the control logic 201, accordingly, instructs the communication module 203 to transmit the alert to the recipient designated by the alert module 209.

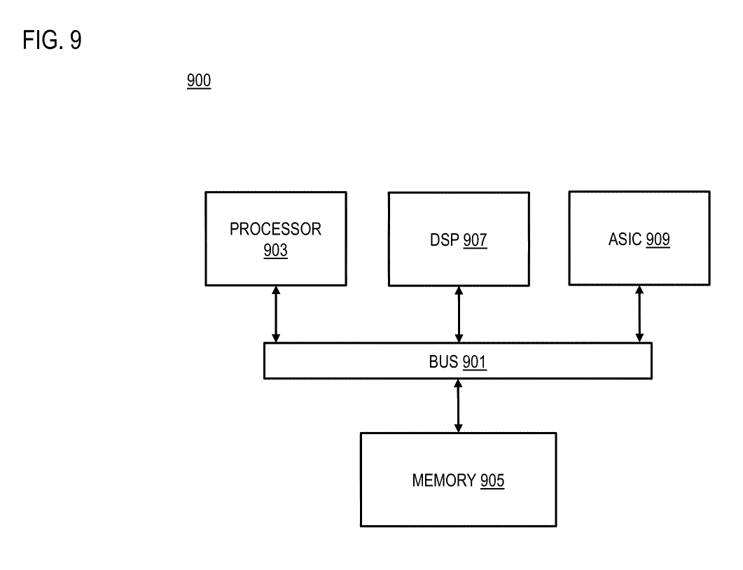

In some embodiments, the behavioral state module 207 and the physiological information management module 205 determines if and when physiological information and/or behavioral states should be added to the user profile and stored in the user profile database 109 (FIG. 9), discussed above to affect any vehicle operator trend analysis that might occur based on the user profile, for example. If the user profile is to be updated, then the vehicle operator performance management platform 103 causes the requisite data to be sent to the network management system 107 for storage in the user profile database 109.

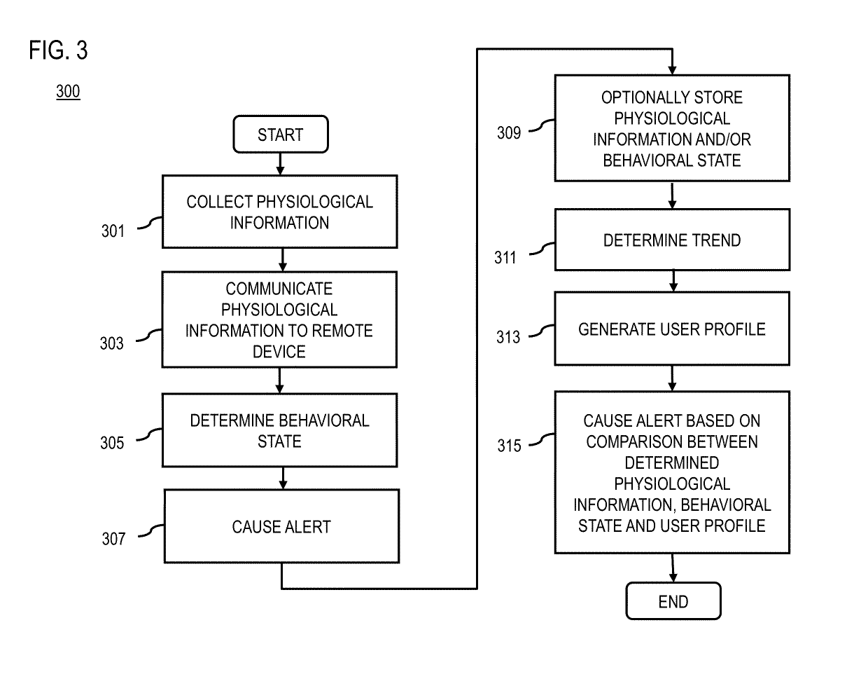

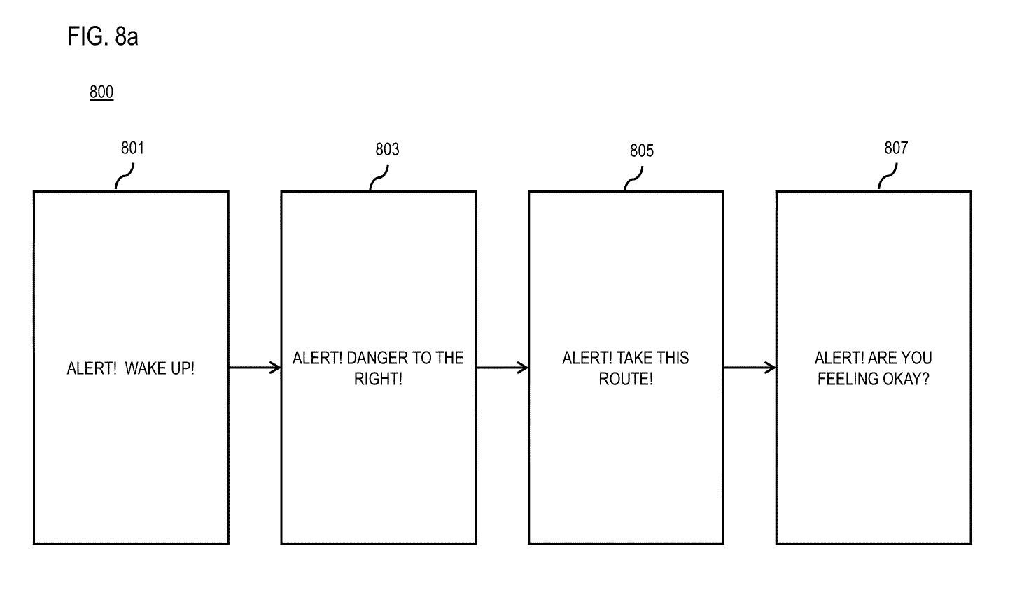

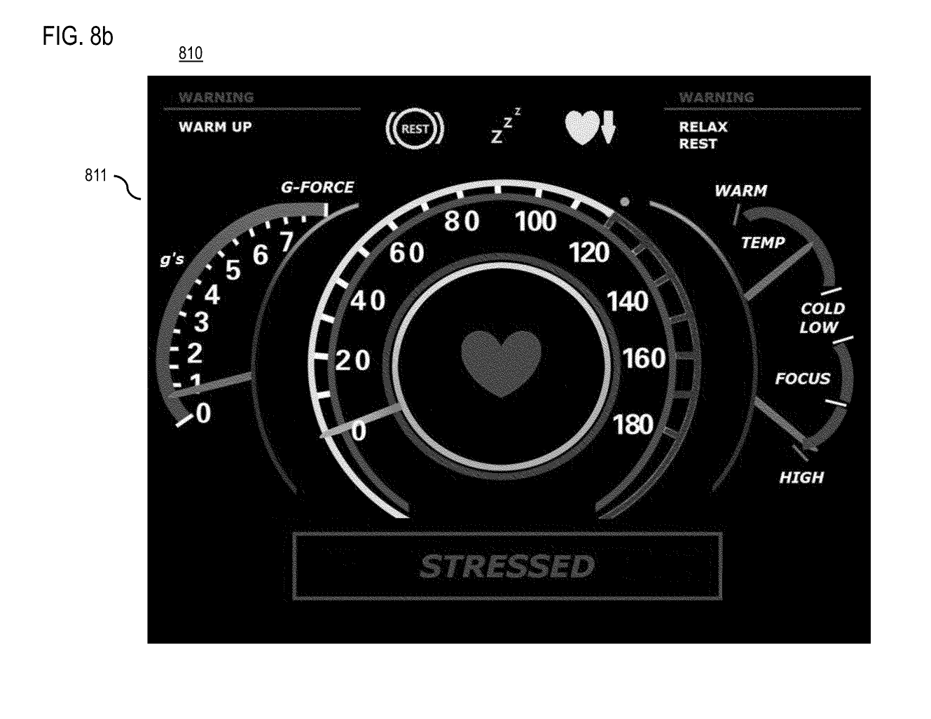

FIG. 3 is a flowchart of a process for determining one or more behavioral states of a vehicle operator and causing one or more alerts and/or one or more management options based on the determined one or more behavioral states, according to one embodiment. In one embodiment, the vehicle operator performance management platform 103 (FIG. 1) performs the process 300 and is implemented in or by, for instance, a chip set including a processor and a memory as shown in FIG. 8. In step 301, the vehicle operator performance management platform 103 causes, at least in part, physiological information associated with a vehicle operator to be collected by one or more sensors associated with one or more of a mobile device, wearable circuitry, a bodily implant, a hand-held control apparatus, a seat portion of a vehicle, an interior of the vehicle, an exterior of the vehicle, or other suitable location by which physiological information of a vehicle operator is collected. The physiological information comprises one or more of a physical position of a vehicle operator, a body temperature of the vehicle operator, a skin temperature of the vehicle operator, a heart rate of the vehicle operator, a movement of the vehicle operator, a g-force experienced by the vehicle operator, a sweat level of the vehicle operator, a blood alcohol content level of the vehicle operator, or other suitable determinable physiological information usable to determine a behavioral state of a physiological condition of the vehicle operator.

Then, in step 303, the vehicle operator performance management platform 103 causes, at least in part, the physiological information to be communicated to a device such as the mobile device, wearable circuitry, other device that is unitarily embodied with, or that is remote from, at least one of the one or more sensors. Next, in step 305, the vehicle operator performance management platform 103 processes the physiological information to determine a behavioral state associated with the vehicle operator. The behavioral state comprises one or more of alert, excited, depressed, involved, uninvolved, energetic, sleepy, fatigued, bored, engaged, disengaged, calm, complacent, distracted, frustrated, stressed, relaxed, peaceful, busy, ready, ideal, confident, happy, joyful, sad, downbeat, impaired, assessed vehicle operator performance, or other determinable behavioral state.

The process continues to step 307 in which the vehicle operator performance management platform 103 causes, at least in part, one or more alerts to be communicated to a device associated with the vehicle operator based, at least in part, on the determined behavioral state.

Then, in step 309, the vehicle operator performance management platform 103 causes, at least in part, one or more of the physiological information and the behavioral state to be stored in a memory, the storage being caused one or more of at the time of collection, at the time of processing, at the time a determined change in physiological information occurs that meets a predefined threshold, at the time a change in behavioral state occurs that meets a predefined threshold, at a predetermined time, and at a predefined interval.

Next, in step 311, the vehicle operator performance management platform 103 determines one or more trends associated with the stored physiological information and the behavioral state. Then, in step 313, the vehicle operator performance management platform 103 causes, at least in part, a user profile to be generated based, at least in part, on the determined one or more trends, the one or more trends optionally indicating a baseline or normal performance of the vehicle operator. As discussed above, the behavioral state is determined based, at least in part, on a comparison of the physiological information and any information available in the user profile such as past behavioral states, past physiological information, etc.

The process continues to step 315 in which the vehicle operator performance management platform 103 causes, at least in part, the one or more alerts to be communicated based, at least in part, on a comparison of the determined behavioral state and the user profile.

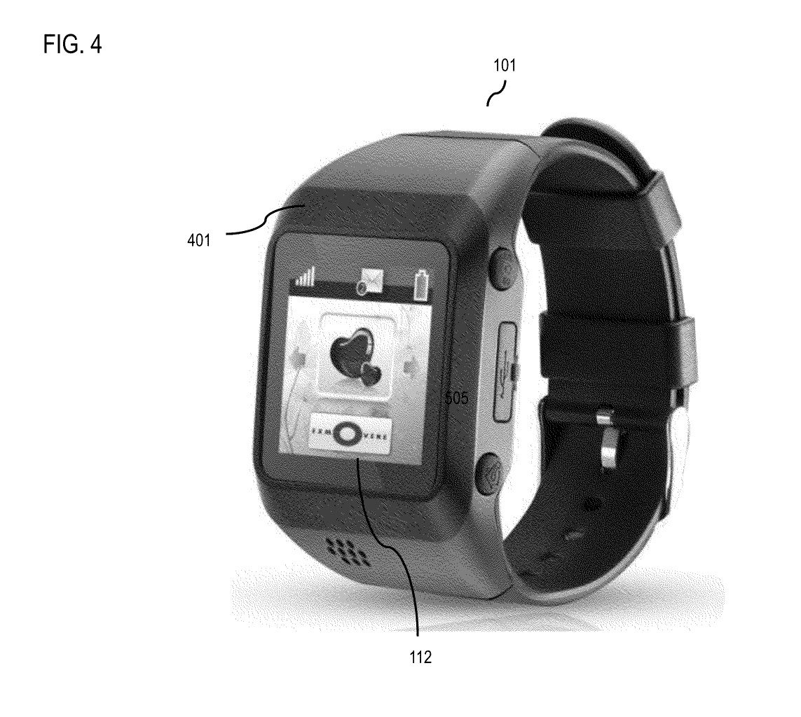

FIG. 4 is a diagram of a wearable UE 101, in accordance with one or more embodiments. In this example, the UE 101 is a body-mounted device 401 having network connectivity to the communication network 105, discussed above. The body-mounted device 401 is configured to collect physiological information, location information, and one or more of provide data to the above-discussed vehicle operator performance management platform 103 (FIG. 1) and communicate with a vehicle operator by way of user interface 112.

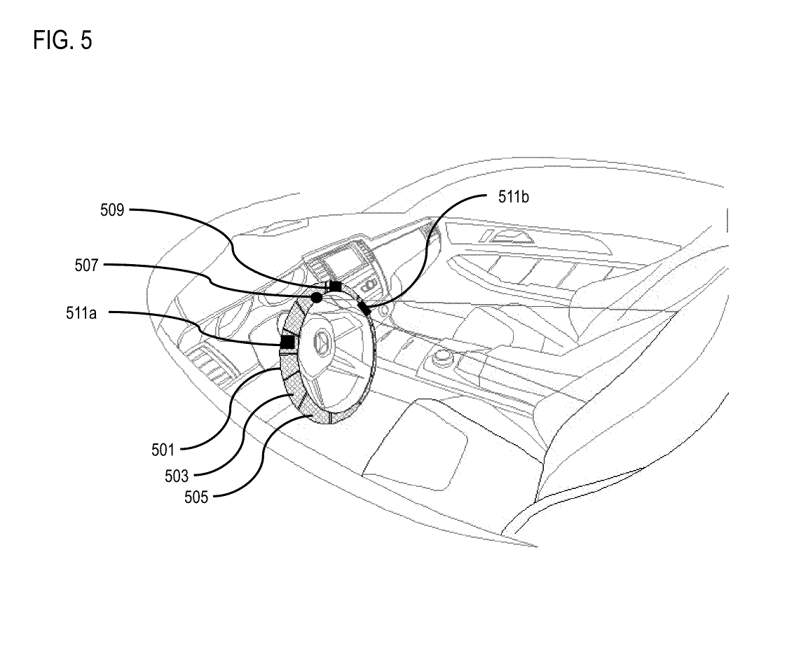

FIG. 5 is a diagram of a hand-operated control device configured to collect physiological information associated with a vehicle operator, in accordance with one or more embodiments. In this example, the hand-operated control apparatus 501 includes a cover portion 503. The cover portion 503 is separately attached or integrally formed with the hand-operated control apparatus 501. In one or more embodiments, the features discussed with regard to the hand-operated control apparatus 501 are one or more of a part of solely the cover portion 503, or a part of the hand-operated control apparatus 501 as a whole. In this example, the cover portion 503 includes multiple parts 505 that are separate sensory inputs or input areas for determining hand position on the hand-operated control apparatus 501. For example, the multiple parts 505 are themselves sensors 111 (FIG. 1), as discussed above, or include various sensors 111, as discussed above. The cover portion 503 also includes an infrared temperature sensor 507. The cover portion 503, as discussed above, includes a communication unit 509 configured to communicate collected physiological information to the UE 101 (FIG. 1) and/or the vehicle operator performance management platform 103 (FIG. 1). In this example embodiments, the cover portion 503 also includes haptic alert units 511a and 511b. The haptic alert units 511a and 511b are configured, in this example, to provide a sensory indication that an alert has been given and to provide a directional indication of a possible obstruction that is in a predicted path of movement of the vehicle.

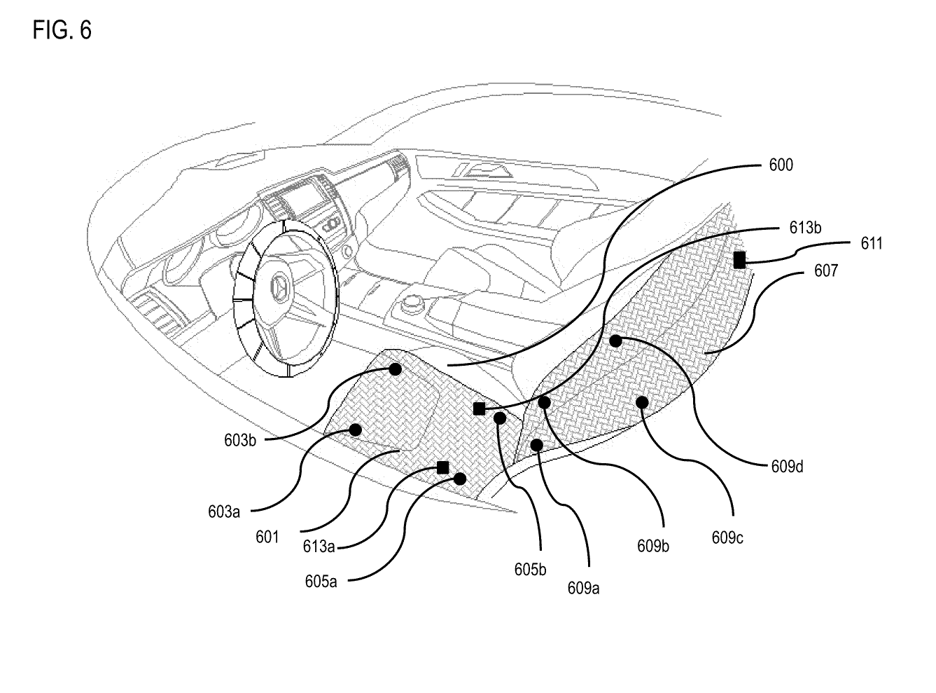

FIG. 6 is a diagram of a seat portion of a vehicle operated by a vehicle operator configured to collect physiological information associated with the vehicle operator, according to one embodiment. In this example, a seat portion 600 includes a cover portion 601. The cover portion 601 includes two thigh sensors 603a and 603b, and two buttock sensors 605a and 605b (collectively referred to as sensors 605). The seat portion 600 also includes a back portion 607 that includes four back pressure sensors 609a-609d (collectively referred to as sensors 609). As discussed above, the cover portion 601 of the seat portion 600 is configured to be a part of the seat portion 600 of the vehicle or an entirely separate cover portion. The sensors 603, 605, and 609 are configured to collect physiological information related to determining a posture of a vehicle operator.

In some embodiments, as discussed above, cover portion 601 includes a communication unit 611 configured to communicate collected physiological information to the UE 101 (FIG. 1) and/or the vehicle operator performance management platform 103 (FIG. 1), for example. In this example embodiments, the cover portion 601 also includes haptic alert units 613a and 613b. The haptic alert units 613a and 613b are configured to provide a sensory indication that an alert has been given and may, as discussed above, be configured to provide directional indication of a possible obstruction that is in a predicted path of movement of the vehicle.

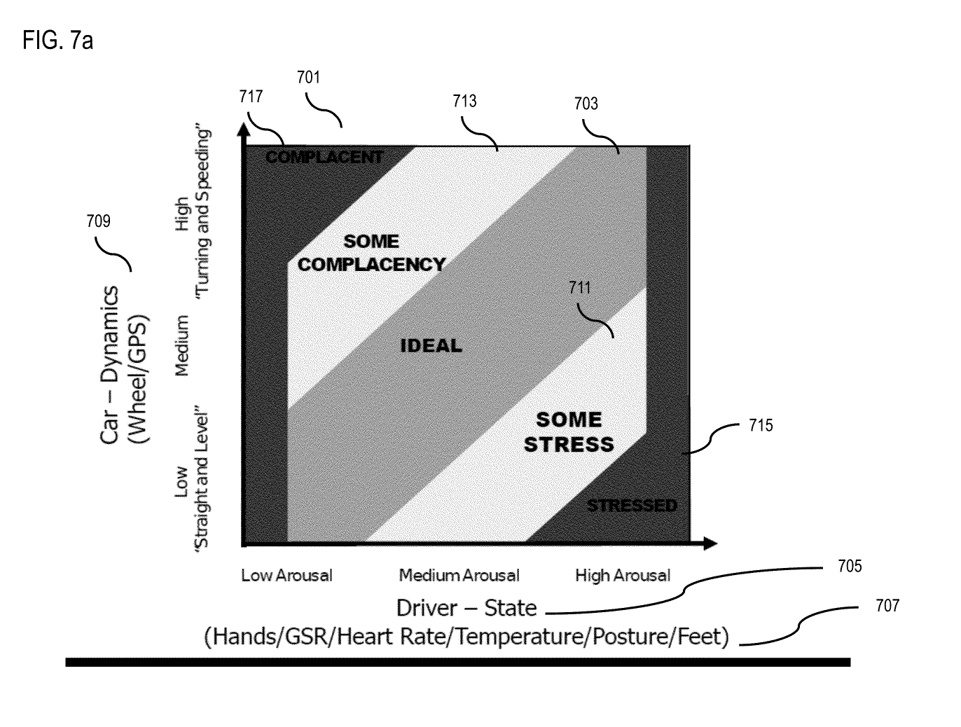

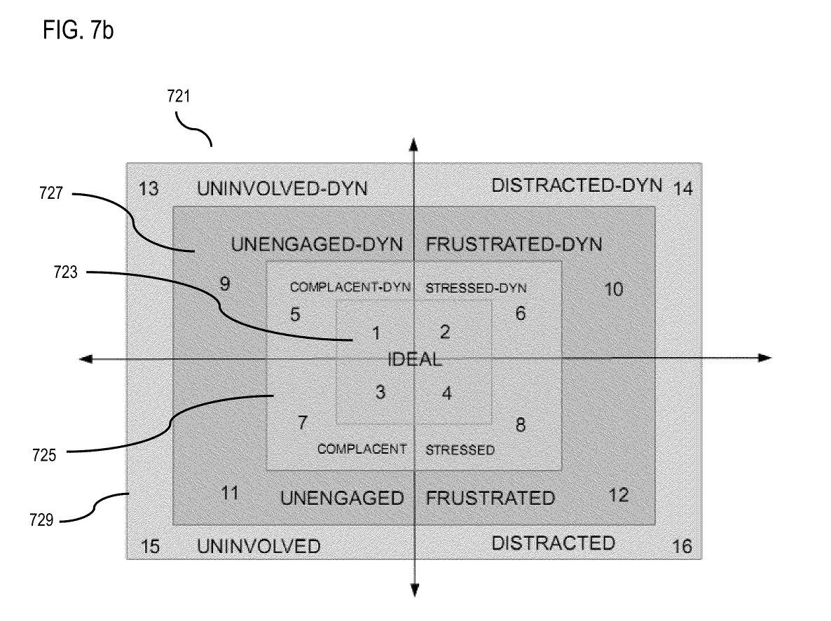

FIG. 7a is a chart illustrating the categorization of particular behavioral states based on physiological information and vehicle performance, in accordance with one or more embodiments. The chart 701 illustrates an ideal operating condition 703 occurs when particular combinations of particular behavioral states 705 based on collected physiological information 707 and vehicle performance indicators 709 occur. The chart 701 illustrates some stress 711 based on a combination of a particular behavioral state 705 and a vehicle performance indicator 709. The chart 701 illustrates some complacency 713 based on a combination of a particular behavioral state 705 and a vehicle performance indicator 709. The chart 701 illustrates that the vehicle operator is complacent 715 based on a combination of a particular behavioral state 705 and a vehicle performance indicator 709. The chart 701 illustrates the vehicle operator is stressed 717 based on a combination of a particular behavioral state 705 and vehicle performance indicator 709.

Any of the determined indications of ideal, complacent, some complacency, stressed, some stress, or other suitable determined behavioral states such as those discussed above, may be a ground for causing an alert, and may also be used for establishing a user profile to determine a baseline for comparison to determine if an alert should be sent, as discussed above.

FIG. 7b is a chart illustrating what particular degrees of divergence from the ideal operating condition indicates, based on predetermined variation standardizations, for example. In chart 721, an ideal state of vehicle operator performance occurs in box 723. Box 723 indicates an ideal behavioral states based on combinations of ideal physiological information, and/or ideal vehicle operation performance, etc. A first level variation 725 from the ideal state 723 in a particular direction indicates that the vehicle operator is complacent, stressed, somewhat complacent, or somewhat stressed depending on the degree of change in a determined behavioral state, physiological information, and/or vehicle operation performance. From such a variation from the ideal state 723, a further deviation such as that indicated by a more serious infraction 727 indicates that a vehicle operator is unengaged, somewhat unengaged, frustrated, or somewhat frustrated. Even still further away from the ideal state 723 is an even more serious infraction 729 that indicates that a vehicle operator is any of uninvolved, somewhat uninvolved, distracted, or somewhat distracted.

In some embodiments, an alert is caused to be sent to the UE 101 and/or the network management system 107 discussed above based on a preset indication of which level of deviation from the ideal state 723 should cause an alert, what kind of alert that is, and to whom the alert is to be sent.

In some embodiments, changes in vehicle operator status as determined by the vehicle operator performance management platform 103 from ideal to uninvolved and/or distracted, and any determined types of status changes therebetween, as determined by the vehicle operator performance management platform 103 causes the vehicle operator status to be stored in the user profile database 109 (FIG. 1), as well as the determined behavioral state at that time, physiological information, vehicle operating conditions, vehicle operating performance, etc. to develop the user profile and provide analytical data to the network management system 107 (FIG. 1) for evaluation of a vehicle operator.

According to various embodiments, different types of sensors 111 (FIG. 1) and/or different placement of the sensors 111 are capable of collecting different types of physiological information 707. In some embodiments, the vehicle operator performance management platform 103 is configured to determine whether the UE 101, for example, is positioned on a top or on a bottom of a vehicle operator's wrist. If on the top of the vehicle operator's wrist, the vehicle operator performance management platform 103 is optionally configured to determine twelve behavioral states 705 including, for example, whether a vehicle operator is frustrated, stressed, busy, energetic, excited, joyful, bored, fatigued, depressed, calm, relaxed or peaceful. Alternatively, if the vehicle operator performance management platform 103 determines the UE 101 is positioned on the bottom of the vehicle operator's wrist, the vehicle operator performance management platform 103 is configured to determined sixteen behavioral states 705 including, for example, whether a vehicle operator is distracted, frustrated, stressed, alert, engaged, excited, joyful, impaired, bored, downbeat, fatigued, disengaged, confident, relaxed, sleepy, or unaware.

The differences in capability of the vehicle operator performance management platform 103 are based, for example, on the types of physiological information 707 that is capable of being determined based on the position of the UE 101 and/or the sensors 111 with respect to the vehicle operator. In some embodiments, depending on the type of alert or message the vehicle operator performance management platform 103 generates or causes to be viewed by way of UE 101, the message optionally includes an instruction or orient or place the UE 101 in a particular location or arrangement with respect to the vehicle operator such as on top of the wrist, below the wrist, or in the palm of vehicle operator to selectively collect particular physiological information 707.

In some embodiments, the behavioral states 705 are grouped and organized with respect to severity, such as that discussed with respect to FIG. 7b. For example, in order of severity, if the UE 101 is worn on top of the wrist, a first group of behavioral states 705 includes whether a vehicle operator is busy, stressed, or frustrated, a second group of behavioral states 705 includes whether the vehicle operator is energetic, excited, or joyful, a third group of behavioral states 705 includes whether the vehicle operator is bored, fatigued, or depressed, and a fourth group of behavioral states 705 includes whether the vehicle operator is calm, relaxed or peaceful.

If the UE 101 is worn on the bottom of the wrist, in order of severity, a first group of behavioral states 705 includes whether a vehicle operator is alert, stressed, frustrated, or distracted, a second group of behavioral states 705 includes whether the vehicle operator is engaged, excited, joyful, or impaired, a third group of behavioral states 705 includes whether the vehicle operator is bored, downbeat, fatigued, or disengaged, and a fourth group of behavioral states 705 includes whether the vehicle operator is confident, relaxed, sleepy, or unaware.

FIG. 8a illustrates diagrams of example user interfaces utilized in the processes of FIG. 3, according to various embodiments. User interface display 801 indicates an alert associated with vehicle operator fatigue. User interface display 803 indicates an alert associated with a perceived danger that corresponds to a detected obstruction that may interfere with a predicted direction of movement of the vehicle. User interface 805 indicates an alert associated with a suggested change in navigational route. Alerts additionally, or alternatively, include messages or suggestions that suggest performing various exercises, changing behavior, taking a break, managing stress, or other suitable message as discussed above to manage stress and comfort levels of the vehicle operator, thereby promoting safety and efficient vehicle operation based on a determined behavioral state or drive time, for example. User interface 807 indicates a question to be answered by the vehicle operator. In some embodiments, the vehicle operator's response is factored into determining a behavioral state and/or trend to be stored in the user profile. For example, is the vehicle operator fatigued, but often fails to tell the truth about his fatigue.

FIG. 8b illustrates an example user interface utilized in the processes of FIG. 3, according to various embodiments. User interface display 810 is an all-in one dashboard-style user interface that includes a display of metrics such as various physiological information, vehicle speed, g-forces experienced, behavioral states, alerts, messages, etc.

In some embodiments, the vehicle operator performance management platform 103 (FIG. 1) is configured to determine if the vehicle operator is inside or outside the vehicle and if the vehicle operator is driving the vehicle. The vehicle operator performance management platform 103, optionally causes the user interface 112 (FIG. 1) of the UE 101 (FIG. 1) to display the user interface 810 and cause the user interface 810 to remain active until a determined vehicle operation period has passed. Such activation of the user interface 810, for example, makes it possible for the vehicle operator to check the information made available by way of the user interface 810 without having to activate the user interface 112 of the UE 101 while operating the vehicle.

The processes described herein for determining one or more behavioral states of a vehicle operator and causing one or more alerts and/or one or more management options based on the determined one or more behavioral states may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

FIG. 9 illustrates a chip set or chip 900 upon which an embodiment may be implemented. Chip set 900 is programmed to determine one or more behavioral states of a vehicle operator and cause one or more alerts and/or one or more management options based on the determined one or more behavioral states as described herein may include, for example, bus 901, processor 903, memory 905, DSP 907 and ASIC 909 components.

The processor 903 and memory 905 may be incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 900 can be implemented in a single chip. It is further contemplated that in certain embodiments the chip set or chip 900 can be implemented as a single “system on a chip.” It is further contemplated that in certain embodiments a separate ASIC would not be used, for example, and that all relevant functions as disclosed herein would be performed by a processor or processors. Chip set or chip 900, or a portion thereof, constitutes a means for performing one or more steps of determining one or more behavioral states of a vehicle operator and causing one or more alerts and/or one or more management options based on the determined one or more behavioral states.

In one or more embodiments, the chip set or chip 900 includes a communication mechanism such as bus 901 for passing information among the components of the chip set 900. Processor 903 has connectivity to the bus 901 to execute instructions and process information stored in, for example, a memory 905. The processor 903 may include one or more processing cores with each core configured to perform independently. A multi-core processor enables multiprocessing within a single physical package. Examples of a multi-core processor include two, four, eight, or greater numbers of processing cores. Alternatively or in addition, the processor 903 may include one or more microprocessors configured in tandem via the bus 901 to enable independent execution of instructions, pipelining, and multithreading. The processor 903 may also be accompanied with one or more specialized components to perform certain processing functions and tasks such as one or more digital signal processors (DSP) 907, or one or more application-specific integrated circuits (ASIC) 909. A DSP 907 typically is configured to process real-world signals (e.g., sound) in real time independently of the processor 903. Similarly, an ASIC 909 can be configured to performed specialized functions not easily performed by a more general purpose processor. Other specialized components to aid in performing the functions described herein may include one or more field programmable gate arrays (FPGA), one or more controllers, or one or more other special-purpose computer chips.

In one or more embodiments, the processor (or multiple processors) 903 performs a set of operations on information as specified by computer program code related to determining one or more behavioral states of a vehicle operator and causing one or more alerts and/or one or more management options based on the determined one or more behavioral states. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 901 and placing information on the bus 901. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 903, such as a sequence of operation codes, constitute processor instructions, also called computer system instructions or, simply, computer instructions. Processors may be implemented as mechanical, electrical, magnetic, optical, chemical or quantum components, among others, alone or in combination.

The processor 903 and accompanying components have connectivity to the memory 905 via the bus 901. The memory 905 may include one or more of dynamic memory (e.g., RAM, magnetic disk, writable optical disk, etc.) and static memory (e.g., ROM, CD-ROM, etc.) for storing executable instructions that when executed perform the steps described herein to determining one or more behavioral states of a vehicle operator and causing one or more alerts and/or one or more management options based on the determined one or more behavioral states. The memory 905 also stores the data associated with or generated by the execution of the steps.

In one or more embodiments, the memory 905, such as a random access memory (RAM) or any other dynamic storage device, stores information including processor instructions for determining one or more behavioral states of a vehicle operator and causing one or more alerts and/or one or more management options based on the determined one or more behavioral states. Dynamic memory allows information stored therein to be changed by system 100. RAM allows a unit of information stored at a location called a memory address to be stored and retrieved independently of information at neighboring addresses. The memory 905 is also used by the processor 903 to store temporary values during execution of processor instructions. The memory 905 may also be a read only memory (ROM) or any other static storage device coupled to the bus 901 for storing static information, including instructions, that is not changed by the system 100. Some memory is composed of volatile storage that loses the information stored thereon when power is lost. The memory 905 may also be a non-volatile (persistent) storage device, such as a magnetic disk, optical disk or flash card, for storing information, including instructions, that persists even when the system 100 is turned off or otherwise loses power.

The term “computer-readable medium” as used herein refers to any medium that participates in providing information to processor 903, including instructions for execution. Such a medium may take many forms, including, but not limited to computer-readable storage medium (e.g., non-volatile media, volatile media), and transmission media. Non-volatile media includes, for example, optical or magnetic disks. Volatile media include, for example, dynamic memory. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

While a number of embodiments and implementations have been described, the disclosure is not so limited but covers various obvious modifications and equivalent arrangements, which fall within the purview of the appended claims. Although features of various embodiments are expressed in certain combinations among the claims, it is contemplated that these features can be arranged in any combination and order.

What is claimed is:

1. A method comprising:
causing, at least in part, physiological information associated with a vehicle operator to be collected by one or more sensors;
causing, at least in part, the physiological information to be communicated to a device that comprises at least one of the one or more sensors or is remote from at least one of the one or more sensors;
processing the physiological information to determine a behavioral state associated with the vehicle operator; and
causing, at least in part, one or more alerts to be communicated to a device associated with the vehicle operator based, at least in part, on the determined behavioral state.

2. A method of claim 1, further comprising:
causing, at least in part, one or more of the physiological information and the behavioral state to be stored in a memory, the storage being caused one or more of at the time of collection, at the time of processing, at the time a determined change in physiological information occurs that meets a predefined threshold, at the time a change in behavioral state occurs that meets a predefined threshold, at a predetermined time, and at a predefined interval;
determining one or more trends associated with the stored physiological information and the behavioral state; and
causing, at least in part, a user profile to be generated based, at least in part, on the determined one or more trends,
wherein the behavioral state is determined based, at least in part, on a comparison of the physiological information and the user profile.

3. A method of claim 2, further comprising:
causing, at least in part, the one or more alerts to be communicated based, at least in part, on a comparison of the determined behavioral state and the user profile.

4. A method of claim 1, wherein the physiological information comprises one or more of a physical position of the vehicle operator, a body temperature of the vehicle operator, a heart rate of the vehicle operator, a movement of the vehicle operator, a sweat level of the vehicle operator, and a blood alcohol content level of the vehicle operator.

5. A method of claim 1, wherein the one or more sensors comprise one or more sensors in contact with the vehicle operator.

6. A method of claim 5, wherein at least one of the one or more sensors is configured to determine one or more of a speed and a direction of movement of the vehicle operator, the behavioral state of the vehicle operator being based, at least in part, on the speed and direction of movement of the vehicle operator.

7. A method of claim 1, wherein the one or more sensors comprise one or more sensors associated with determining a posture of the vehicle operator, the behavioral state being based, at least in part, on the determined posture of the vehicle operator.

8. A method of claim 1, wherein the behavioral state comprises one or more of alert, excited, depressed, involved, uninvolved, energetic, sleepy, fatigued, bored, engaged, disengaged, calm, complacent, distracted, frustrated, stressed, relaxed, peaceful, busy, ready, ideal, confident, happy, joyful, sad, and downbeat.

9. An apparatus comprising:
at least one processor; and
at least one memory including computer program code for one or more programs,
the at least one memory and the computer program code configured to, with the at least one processor, cause the apparatus to perform at least the following:
cause, at least in part, physiological information associated with a vehicle operator to be collected by one or more sensors;
cause, at least in part, the physiological information to be communicated to a device that comprises at least one of the one or more sensors or is remote from at least one of the one or more sensors;
process the physiological information to determine a behavioral state associated with the vehicle operator; and
cause, at least in part, one or more alerts to be communicated to a device associated with the vehicle operator based, at least in part, on the determined behavioral state.

10. An apparatus of claim 9, wherein the apparatus is further caused to:
cause, at least in part, one or more of the physiological information and the behavioral state to be stored in a memory, the storage being caused one or more of at the time of collection, at the time of processing, at the time a determined change in physiological information occurs that meets a predefined threshold, at the time a change in behavioral state occurs that meets a predefined threshold, at a predetermined time, and at a predefined interval;
determine one or more trends associated with the stored physiological information and the behavioral state; and
cause, at least in part, a user profile to be generated based, at least in part, on the determined one or more trends,
wherein the behavioral state is determined based, at least in part, on a comparison of the physiological information and the user profile.

11. An apparatus of claim 10, wherein the apparatus is further caused to:
cause, at least in part, the one or more alerts to be communicated based, at least in part, on a comparison of the determined behavioral state and the user profile.

12. An apparatus of claim 9, wherein the physiological information comprises one or more of a physical position of the vehicle operator, a body temperature of the vehicle operator, a heart rate of the vehicle operator, a movement of the vehicle operator, a sweat level of the vehicle operator, and a blood alcohol content level of the vehicle operator.

13. An apparatus of claim 9, wherein the one or more sensors comprise one or more sensors in contact with the vehicle operator.

14. An apparatus of claim 13, wherein at least one of the one or more sensors is configured to determine one or more of a speed and a direction of movement of the vehicle operator, the behavioral state of the vehicle operator being based, at least in part, on the speed and direction of movement of the vehicle operator.

15. An apparatus of claim 9, wherein the one or more sensors comprise one or more sensors associated with determining a posture of the vehicle operator, the behavioral state being based, at least in part, on the determined posture of the vehicle operator.

16. An apparatus of claim 9, wherein the behavioral state comprises one or more of alert, excited, depressed, involved, uninvolved, energetic, sleepy, fatigued, bored, engaged, disengaged, calm, complacent, distracted, frustrated, stressed, relaxed, peaceful, busy, ready, ideal, confident, happy, joyful, sad, and downbeat.

17. A method comprising:
causing, at least in part, physiological information associated with a vehicle operator to be collected by one or more sensors;
causing, at least in part, the physiological information to be communicated to a device that comprises at least one of the one or more sensors or is remote from at least one of the one or more sensors;
processing the physiological information to determine a behavioral state associated with the vehicle operator;
determining one or more trends associated with the stored physiological information and the behavioral state;
causing, at least in part, a user profile to be generated based, at least in part, on the determined one or more trends, the behavioral state being determined based, at least in part, on a comparison of the physiological information and the user profile; and
facilitating access to the user profile by a management system associated with a vehicle occupied by the vehicle operator, the management system being capable of monitoring the vehicle operator based, at least in part, on accessing the user profile.

18. The method of claim 17, further comprising:
causing, at least in part, operation of the vehicle to be controlled by the management system based, at least in part, on the determined behavioral state.

19. The method of claim 17, further comprising:
causing, at least in part, one or more alerts to be communicated to the management system based, at least in part, on the determined behavioral state; and
facilitating a communication between the management system and vehicle operator in response a reception of the one or more alerts.

20. The method of claim 17, wherein the behavioral state comprises one or more of alert, excited, depressed, involved, uninvolved, energetic, sleepy, fatigued, bored, engaged, disengaged, calm, complacent, distracted, frustrated, stressed, relaxed, peaceful, busy, ready, ideal, confident, happy, joyful, sad, and downbeat.
